(19) United States
(12) Patent Application Publication
(10) Pub. No.: US 2026/0304105 A1
(43) Pub. Date: Oct. 1, 2026

(54) METHODS AND DEVICES FOR INFORMATION INDICATION

(71) Applicant: Telefonaktiebolaget LM Ericsson (publ), Stockholm (SE)

(72) Inventors: Lin JIN, Shanghai (CN); Yunjie LU, Shanghai (CN); Yong YANG, Kållered (SE)

(73) Assignee: Telefonaktiebolaget LM Ericsson (publ), Stockholm (SE)

(21) Appl. No.: 19/480,911

(22) PCT Filed: Mar. 27, 2024
(86) PCT No.: PCT/CN2024/084055

§ 371 Date: Nov. 3, 2025

(30) Foreign Application Priority Data
May 4, 2023 (WO) PCT/CN2023/092041

(51) Int. Cl. H04W 8/24

(52) U.S. Cl. CPC H04W 8/24

(57) ABSTRACT

Embodiments of the present disclosure provide methods and network devices for information indication in a wireless communication network. A method performed by a first network device (10) may comprise: acquiring (S501, S601) a first indication indicating whether a second network device (20) supports a feature of assigning an identifier to represent a set of capabilities supported by a terminal device; sending (S503, S603) to the second network device (20) a first identifier of a set of capabilities supported by a first terminal device instead of the set of capabilities supported by the first terminal device, if the first indication indicates the second network device (20) supports the feature.

### CROSS REFERENCE TO RELATED APPLICATION

This application claims priority of PCT Application Serial Number PCT/CN2023/092041 filed on May 4, 2023 with title of “METHODS AND DEVICES FOR INFORMATION INDICATION”, the entire contents of which are incorporated herein by reference.

### TECHNICAL FIELD

The non-limiting and exemplary embodiments of the present disclosure generally relate to the technical field of communications, and specifically to methods and network devices for information indication in a communication network.

### BACKGROUND

This section introduces aspects that may facilitate a better understanding of the present disclosure. Accordingly, the statements of this section are to be read in this light and are not to be understood as admissions about what is in the prior art or what is not in the prior art.

In a communication network, there are usually many terminal devices. Communication with the terminal devices usually should be based on their capabilities, such as radio capabilities in a wireless communication network, for example, supporting bands and/or band combinations. Network devices may need to know a terminal device's capabilities to provide it with propriate services. For example, in a fifth Generation (5G) system, next generation-radio access network (NG-RAN) may need to know a User Equipment (UE)'s capabilities during access and mobility procedures.

However, a terminal device's capabilities are richer and richer, with new added frequency bands. In clause 5.1 of the 3rd Generation Partnership Project (3GPP) Technical Report (TR) 37.873 V16.0.0 (2019-03), there is following description about the size of UE Radio Capability: “For New Radio (NR) and Evolved Universal Terrestrial Radio Access (EUTRA)-NR Dual Connection (EN-DC), based on the newly introduced structure for UE capability in Rel-15, the size of the UE capability is dominated by rf-Parameters, featureSetCombinations and featureSets. The estimated theoretical maximum size of UE radio capabilities for NR or EN-DC (based on the maximum sizes in Abstract Syntax Notation One (ASN.1)) can approximate to 10000 kbytes. According to Long Term Evolution (LTE) experience and analysis of the NR capability, the estimated practical size of rf-Parameters (radio frequency parameters) is about 11~12 kbytes based on ~1024 band combinations and up to 4 bands per band combination.”

Considering big size of a terminal device's capabilities, there should be a solution which can efficiently transmit the information between network devices.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

To overcome or mitigate at least one of the above mentioned problems or other problems, an improved solution for information indication may be desirable, to provide an efficient way of transmitting terminal devices' capabilities between network devices. With the solution provided in the present disclosure, a first network device in a communication network (such as a wireless communication network) can acquire whether a second network device supports a feature of transmitting identifiers of sets of capabilities supported by terminal devices, in other words, a feature of assigning an identifier to represent a set of capabilities supported by a terminal device. If the second network device supports the feature, the first network device then can send the identifier of a set of capabilities instead of the set of capability. The communication network can be any type of network providing communications to terminal devices. Network devices are devices except the terminal devices which provides the network infrastructure for communications.

In a first aspect of the present disclosure, there is provided a method performed by a first network device in a communication network. In the method, a first network device may acquire a first indication indicating whether a second network device supports a feature of assigning an identifier to represent a set of capabilities supported by a terminal device. The first network device may to the second network device a first identifier of a set of capabilities supported by a first terminal device instead of the set of capabilities supported by the first terminal device, if the first indication indicates the second network device supports the feature.

With the indication, the first network device can know how to convey a set of capabilities supported by a terminal device to the second network device. If the indication indicates that the second network device supports the above-mentioned feature, the first network device can send an identifier of a set of capabilities to the second network device instead of the set of the capabilities, which can reduce size of information transmitted; otherwise, the first network device can send the set of capabilities to the second network device. If the first network device knows in advance that the second network device does not support the feature, it will not transmit identifiers of sets of capabilities, which avoids failure response from the second network device and retransmission of the set of capabilities by the first network device.

In an embodiment, the first network device may acquire the first indication by receiving the first indication from the second network device, or by storing the first indication; or by acquiring the first indication from a third network device storing the second network device's supporting features. If the first network device receives the first indication from the second network device, optionally, it may receive the first indication in an existing message with the second network device. So, no new message needed to be involved for the transmission of the first indication, saving signalling cost.

In an embodiment, the first network device may store the first indication after receiving or acquiring it. So next time when there is a requirement to convey a terminal device's set of capabilities to the second network device, the first network device can refer to the stored first indication of the second network device to decide whether to send an identifier or a set of capabilities.

There are two scenarios:
i) the first indication indicates the second network device supports the feature;
ii) the first indication indicates the second network device does not support the feature.

In the scenario i), the first network device may further send to the second network device a first identifier of a set of capabilities supported by a first terminal device in a dedicated message for the first terminal device.

However, although the second network device supports the feature, it may not have the corresponding set of capabilities identified by the first identifier, so in an embodiment, after sending the first identifier to the second network device, the first network device may further receive from the second network device a first request for acquiring the set of capabilities identified by the first identifier, and in response to the first request, send to the second network device a first response including the set of capabilities identified by the first identifier.

Furthermore, the first network device may itself only store the first identifier of the set of capabilities supported by the first terminal device, not store corresponding set of capabilities, so in an embodiment, after receiving the first request, the first network device may further send a second request to a fourth network device storing identifiers and corresponding sets of capabilities supported by terminal devices identified by each identifier, for acquiring the set of capabilities identified by the first identifier; and receive from the fourth network device a second response including the set of capabilities identified by the first identifier, then the terminal device can include the received set of capabilities in the first response and send to the second network device.

With the above procedure, the second network device can get both the identifier and the identified set of capabilities, it may store the identifier in correlation with the identified set of capabilities for use in future (with the same identifier), saving the signalling cost and also achieving information alignment between network devices.

In the scenario ii) wherein the first network device supports the feature and the first indication indicates the second network device does not support the feature, the first network device may send to the second network device a set of capabilities supported by a second terminal device in a dedicated message for the second terminal device. For the first network device knows in advance that the second network device does not support the feature, it will not send the identifier of a set of capabilities to the second network device, which avoids a signalling procedure failure and improve signalling efficiency.

Similarly, the first network device may itself not store the set of capabilities supported by the second terminal device, so, before sending the set of capabilities, it may further acquire from the fourth network device. Optionally, it may send a third request for acquiring the set of capabilities identified by a second identifier to the fourth network device, wherein the second identifier identifies the set of capabilities supported by the second terminal device; and receive from the fourth network device a third response including the set of capabilities identified by the second identifier.

In a second aspect of the present disclosure, there is provided a method performed by a second network device in a communication network. The second network device may send a first indication to a first network device indicating whether it supports a feature of assigning an identifier to represent a set of capabilities supported by a terminal device. The second network device may further receive from the first network device, a first identifier of a set of capabilities supported by a first terminal device instead of the set of capabilities supported by the first terminal device, if the second network device supports the feature.

With the indication, the first network device can know how to convey sets of capabilities supported by terminal devices to the second network device. If the indication indicates that the second network device supports the above-mentioned feature, the first network device can send an identifier of a set of capabilities to the second network device, which can reduce size of information transmitted; otherwise, the first network device can send the set of capabilities to the second network device. For the first network device knows in advance that the second network device does not support the feature, it will not transmit an identifier of a set of capabilities, which avoids failure response from the second network device and retransmission of the set of capabilities by the first network device.

In an embodiment, the second network device may send the first indication in an existing message with the first network device. So, no new message needed to be involved for the transmission of the first indication, saving signalling cost.

There are two scenarios:
i) the second network device supports the feature;
ii) the second network device does not support the feature.

In the scenario i), the second network device may further receive from the first network device a first identifier of a set of capabilities supported by a first terminal device in a dedicated message for the first terminal device. For the second network device sends the first indication in advance to the first network device, indicating it supports the feature. So, the first network device sends the first identifier, which saves signalling cost by avoiding transmitting big size of a set of capabilities.

In an embodiment, after receiving the first identifier, the second network device may further determine whether having the set of capabilities identified by the first identifier, if not, the second network device may further send to the first network device a first request for acquiring the set of capabilities identified by the first identifier, and receive from the first network device a first response including the set of capabilities identified by the first identifier. With the above procedure, the second network device can get both the identifier and the identified set of capabilities, it may store the identifier in correlation with the identified set of capabilities for use in future (with the same identifier), saving the signalling cost and also achieving information alignment between network devices.

In the scenario ii) wherein the second network device does not support the feature, it may further receive from the first network device, a set of capabilities supported by a second terminal device in a dedicated message for the second terminal device. For the first network device knows in advance that the second network device does not support the feature, it will not send the identifier of a set of capabilities to the second network device, which avoids a signalling procedure failure and improves signalling efficiency.

In a third aspect of the present disclosure, there is provided a first network device. The first network device may comprise at least one processor and at least one memory coupled to the at least one processor, the at least one memory containing instructions executable by the at least one processor, the first network device is operative to execute the method of the first aspect of the present disclosure.

In a fourth aspect of the present disclosure, there is provided a second network device. The second network device may comprise at least one processor and at least one memory coupled to the at least one processor, the at least one memory containing instructions executable by the at least one processor, the second network device is operative to execute the method of the second aspect of the present disclosure.

In a fifth aspect of the present disclosure, there is provided a first network device. The first network device may comprise an information acquisition module, configured to acquire a first indication indicating whether a second network device supports a feature of assigning an identifier to represent a set of capabilities supported by a terminal device.

In a sixth aspect of the present disclosure, there is provided a second network device. The second network device may comprise a sending module, configured to send to a first network device, a first indication indicating whether the second network device supports a feature of assigning an identifier to represent a set of capabilities supported by a terminal device.

In a seventh aspect of the present disclosure, there is provided a communication system comprising a first network device and a second network device according to any above aspect.

In an eighth aspect of the present disclosure, there is provided a computer program product comprising instructions which when executed by a processor, cause the processor to perform the method according to the first or the second aspect.

In any aspect of the present disclosure, the third network device may implement Network Repository Function (NRF).

In any aspect of the present disclosure, the fourth network device may implement UE radio Capability Management Functions (UCMF).

In any aspect of the present disclosure, the first network device may implement an Access and Mobility Management Function (AMF), the second network device is in a Radio Access Network (RAN); or the first network device is a Mobility Management Entity (MME), the second network device is an evolved NodeB (eNB); or the first network device may implement a source AMF, the second network device may implement a target AMF; or the first network device is a source MME, the second network device is a target MME; or the first network device may implement an AMF, the second network device is an MME; or the first network device is an MME, the second network device may implement an AMF.

In any aspect of the present disclosure, the capabilities supported by terminal devices may comprise: radio related capabilities during paging procedures; and/or radio related capabilities during procedures except paging.

In any aspect of the present disclosure, the feature of assigning an identifier to represent a set of capabilities supported by a terminal device is user equipment (UE) radio capability signalling optimisation (RACS).

Embodiments herein may provide many advantages, of which a non-exhaustive list of examples follows. With the indication, the first network device can know how to convey sets of capabilities supported by terminal devices to the second network device. If the indication indicates that the second network device supports the above-mentioned feature, the first network device can send an identifier of a set of capabilities to the second network device, which can reduce size of information transmitted; otherwise, the first network device can send a set of capabilities to the second network device. For the first network device knows in advance that the second network device does not support the feature, it will not transmit identifiers of sets of capabilities, which avoids failure response from the second network device and retransmission of the set of capabilities by the first network device. The embodiments herein are not limited to the features and advantages mentioned above. A person skilled in the art will recognize additional features and advantages upon reading the following detailed description. Here, the word “convey” may mean that no matter of the way the first network device communicates with the second network device, either by sending an identifier of a set of capabilities or sending detailed information of the set of capabilities, as long as the second network device can know which set of capabilities a terminal device support.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the present disclosure and not necessarily drawn to scale, in which:

FIG. 1 shows a present procedure of Initial Context Setup in a 5G system;

FIG. 2 shows an exemplary architecture reference model of a long term evolution (LTE) system;

FIG. 3 shows an exemplary architecture reference model of a 5G system;

FIG. 4 is a schematic showing a communication network in accordance with some embodiments;

FIG. 5 is a schematic signalling chart illustrating interactions between network devices according to embodiments of the present disclosure;

FIG. 6 is a flowchart illustrating methods performed by a first network device according to an embodiment of the present disclosure;

FIG. 7 is a flowchart illustrating methods performed by a second network device according to an embodiment of the present disclosure;

FIG. 8 and FIG. 9 are diagrams illustrating exemplary processes according to embodiments of the present disclosure;

FIG. 10 is a block diagram showing network devices according to embodiments of the present disclosure;

FIG. 11 is a block diagram showing a first network device according to an embodiment of the present disclosure;

FIG. 12 is a block diagram showing a second network device according to an embodiment of the present disclosure.

FIG. 13 is diagram illustrating an example of a communication system in accordance with some embodiments;

FIG. 14 is a block diagram of a host in accordance with various aspects described herein; and

FIG. 15 is a diagram illustrating a communication diagram of a host communicating via a network node with a UE over a partially wireless connection in accordance with some embodiments.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the present disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the present disclosure may be combined in any suitable manner in one or more embodiments. One skilled in the relevant art will recognize that the present disclosure may be practiced without one or more of the specific features or advantages of a particular embodiment. In other instances, additional features and advantages may be recognized in certain embodiments that may not be present in all embodiments of the present disclosure.

Further, following 3GPP documents are incorporated herein by reference in their entireties:

3GPP TR 37.873 V16.0.0 (2019-03), Technical Report, 3rd Generation Partnership Project; Technical Specification Group Radio Access Network; NR and Evolved Universal Terrestrial Radio Access (E-UTRA); Study on optimizations of UE radio capability signalling; (Release 16);

3GPP TS 23.401 V18.1.0 (2023-03), Technical Specification, 3rd Generation Partnership Project; Technical Specification Group Services and System Aspects; General Packet Radio Service (GPRS) enhancements for Evolved Universal Terrestrial Radio Access Network (E-UTRAN) access (Release 18);

3GPP TS 23.501 V18.1.0 (2023-03), Technical Specification, 3rd Generation Partnership Project; Technical Specification Group Services and System Aspects; System architecture for the 5G System (5GS); Stage 2 (Release 18);

3GPP TS 23.502 V18.1.1 (2023-04), Technical Specification, 3rd Generation Partnership Project; Technical Specification Group Services and System Aspects; Procedures for the 5G System (5GS); Stage 2 (Release 18);

3GPP TS 29.518 V18.1.0 (2023-03), Technical Specification, 3rd Generation Partnership Project; Technical Specification Group Core Network and Terminals; 5G System; Access and Mobility Management Services; Stage 3 (Release 18);

3GPP TS 38.413 V17.4.0 (2023-03), Technical Specification, 3rd Generation Partnership Project; Technical Specification Group Radio Access Network; next generation (NG)-Radio Access Network (RAN); NG Application Protocol (NGAP) (Release 17);

GPP TS 38.331 V17.4.0 (2023-03), Technical Specification, 3rd Generation Partnership Project; Technical Specification Group Radio Access Network; new radio (NR)-Radio Resource Control (RRC) protocol specification (Release 17);

3GPP TS 29.500 V18.1.0 (2023-03), Technical Specification, 3rd Generation Partnership Project; Technical Specification Group Core Network and Terminals; 5G System; Technical Realization of Service Based Architecture; Stage 3 (Release 18);

3GPP TS 29.571 V18.1.0 (2023-03), Technical Specification, 3rd Generation Partnership Project; Technical Specification Group Core Network and Terminals; 5G System; Common Data Types for Service Based Interfaces; Stage 3 (Release 18).

Although above 3GPP specifications are in specific versions, embodiments of the present disclosure may be applicable to other versions or versions of other releases. So, the incorporation of the specific version of specification should not be considered as restrictions of the present disclosure.

As described above, there should be an efficient solution to convey a set of capabilities supported by terminal devices between network devices. Also there are some related investigations, such as identifying sets of capabilities with identifiers and transmitting the identifiers instead of detailed information of capabilities.

For example, in 5G system, a feature “UE radio capability signalling optimisation (RACS)” is introduced and there is following description in the clause 5.4.4.1a of 3GPP TS 23.501 V18.1.0 (2023-03): “With the increase of the size of UE radio capabilities driven e.g. by additional frequency bands and combinations thereof for E-UTRA and NR, an efficient approach to signal UE Radio Capability Information over the radio interface and other network interfaces is defined with RACS.” “RACS works by assigning an identifier to represent a set of UE radio capabilities. This identifier is called UE Radio Capability ID. A UE Radio Capability ID can be either UE manufacturer-assigned or Public Land Mobile Network (PLMN)-assigned, as specified in clause 5.9.10. The UE Radio Capability ID is an alternative to the signalling of the UE Radio Capability information over the radio interface, within NG-RAN, from NG-RAN to E-UTRAN, from AMF to NG-RAN and between Core Network (CN) nodes supporting RACS.” “The support of RACS by peer AMFs or Mobility Management Entity (MME)s is based on configuration in a PLMN or across PLMNs.”

But sometimes in a network, not all the devices which need to acquire a terminal device's radio capabilities support such a feature, which may result in message retransmissions, decrease signalling efficiency.

Taking a 5G system as an example, as shown in FIG. 1, during the procedure of Initial Context Setup, in step 1, an AMF supporting the feature RACS may include UE Radio Capability ID in a N2 (reference point between AMF and (R)AN) message (e.g. INITIAL CONTEXT SETUP REQUEST) for the first UE serving by this NG-RAN. In step 2, if the NG-RAN does not support the feature RACS, it shall reject the request with the criticality diagnostics in the response (INTIAL CONTEXT SETUP FAILURE). Then the AMF can know and remember that NG-RAN doesn't support the feature RACS, and will not include UE Radio Capability ID in subsequent N2 messages. Furthermore, in step 3, the AMF has to retry the N2 message for this UE with UE radio capability instead of the UE Radio Capability ID and in step 4, the AMF may receive a successful response from the NG-RAN (INITIAL CONTEXT SETUP RESPONSE).

For there might be thousands of NG-RANs connected to an AMF, the procedure shown in the FIG. 1 may repeat many times for NG-RANs not supporting the feature RACS, which is a waste of signalling and also results in delay to the whole procedure.

The present disclosure proposes an improved solution to avoid unnecessary signalling failures by alignment of feature supporting between devices in a wireless communication network. With the improved solution, a capability sender can know in advance whether a capability receiver supports the feature of receiving identifiers of sets of radio capabilities supported by terminal devices, and based on this, the capability sender can decide whether to transmit an identifier or detailed information of radio capabilities. The improved solution can avoid failure response from the receiver and reducing signalling transmissions.

The solution may be applicable to any network in communication. A network may include network devices and terminal devices. The term “network device” can refer to any node in the network except terminal devices. A network device can be implemented either on a dedicated hardware, or as a software instance running on a dedicated hardware, or as a virtualized function instantiated on an appropriate platform, e.g. on a cloud infrastructure.

The term “terminal device” refers to any end device that can access a network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VoIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP (3rd Generation Partnership Project), such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

As used herein, the term “network” can refer to a network following any suitable communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless systems. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (LG), 2G, 3G, 4G, 4.5G, 5G communication protocols, and/or any other protocols either currently known or to be developed in the future, as long as the network uses HTTP communication.

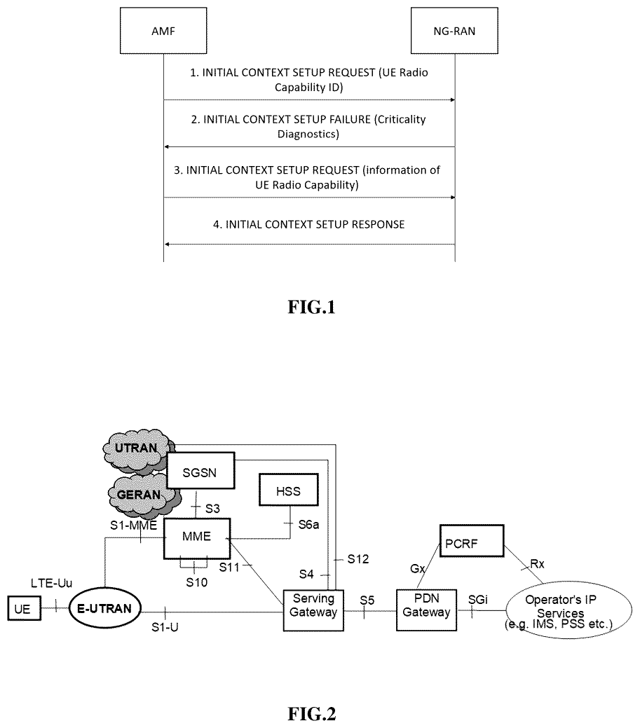

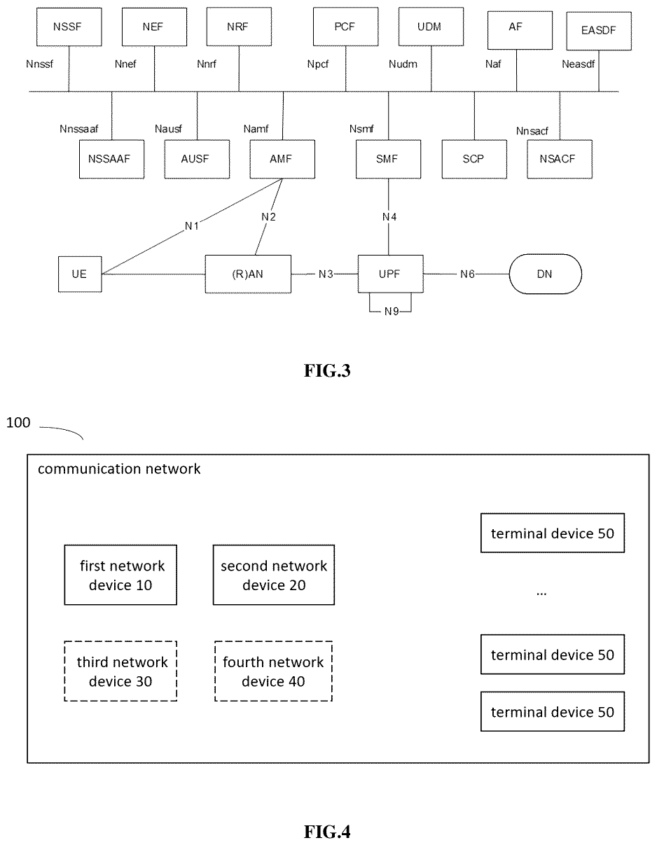

FIG. 2 shows an exemplary architecture reference model of an LTE system. As shown in FIG. 2, a network device can be a Mobile Management Entity (MME), home subscriber server (HSS), Policy and Charging Rules Function (PCRF), Packet Data Network Gateway (PGW), PGW control plane (PGW-C), Serving gateway (SGW), SGW control plane (SGW-C), E-UTRAN Node B (eNB), etc. S1-U, S1-MME, LTE-Uu, S3, S4, S5, S6a, S10, S11, S12, SGi, Gx, Rx are the reference points in the LTE system. Also as shown in FIG. 2, the LTE system can also be connected with a UMTS Terrestrial Radio Access Network (UTRAN) or a GSM EDGE Radio Access Network (GERAN). The LTE system can also receive an operator's IP services (e.g. IP Multimedia Subsystem (IMS), Packet Switching Service (PSS) etc.). Details of the LTE system architecture can be referred to clause 4 of 3GPP TS 23.401 V18.1.0 (2023-03).

FIG. 3 shows an exemplary architecture reference model of a 5G system. In a 5G system, a network device can implement a NF or a network entity, such as a Service Communication Proxy (SCP) or Security Edge Protection Proxies (SEPP). NFs and NF services can communicate directly, referred to as Direct Communication, or indirectly via a SCP, referred to as Indirect Communication. If a network device implements a NF, the NF can be an Authentication Server Function (AUSF), an Access and Mobility Management Function (AMF), a Data Network (DN), e.g. operator services, Internet access or 3rd party services, an Unstructured Data Storage Function (UDSF), a Network Exposure Function (NEF), a Network Repository Function (NRF), a Network Slice Admission Control Function (NSACF), a Network Slice-specific and SNPN Authentication and Authorization Function (NSSAAF), a Network Slice Selection Function (NSSF), a Policy control Function (PCF), a Session Management Function (SMF), a Unified Data Management (UDM), a Unified Data Repository (UDR), a User Plane Function (UPF), a UE radio Capability Management Function (UCMF), an Application Function (AF), a(Radio) Access Network ((R)AN), a 5G-Equipment Identity Register (5G-EIR), a Network Data Analytics Function (NWDAF), a CHarging Function (CHF), a Time Sensitive Networking AF (TSN AF), a Time Sensitive Communication and Time Synchronization Function (TSCTSF), a Data Collection Coordination Function (DCCF), an Analytics Data Repository Function (ADRF), a Messaging Framework Adaptor Function (MFAF), a Non-Seamless WLAN Offload Function (NSWOF) or an Edge Application Server Discovery Function (EASDF), etc. The 5G system architecture may contain following service-based interfaces: Namf, Nsmf, Nnef, Npcf, Nudm, Naf, Nnrf, Nnsacf, Nnssaaf, Nnssf, Nausf, Nudr, Nudsf, N5g-eir, Nnwdaf, Nchf, Nucmf, Ndccf, Nmfaf, Nadrf, Naanf, N5g-ddnmf, Nmbsmf, Nmbsf, Ntsctsf, Nbsp, Neasdf, Nupf. The 5G system architecture may also contain reference points N1, N2, N3, N4, N6, N9, etc.

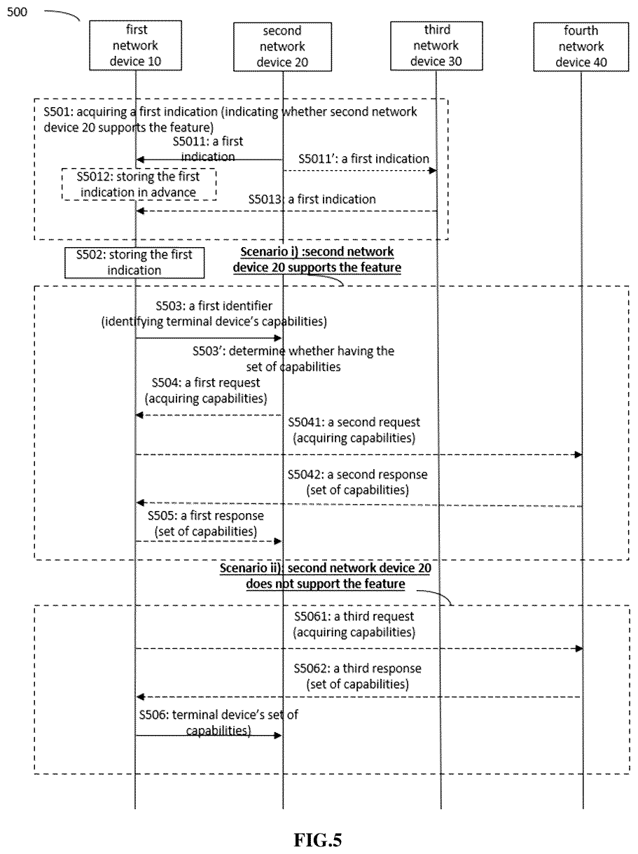

The solution of the present disclosure will be described in detail with reference to FIG. 4 to FIG. 15.

FIG. 4 is a schematic showing a communication network 100 in accordance with some embodiments. As shown in FIG. 4, the network 100 may comprise: a first network device 10 and a second network device 20. The first network device 10 can acquire a first indication indicating whether the second network device 20 supports a feature of assigning an identifier to represent a set of capabilities supported by a terminal device 50. Optionally, the first network device 10 supports the feature and with the first indication, the first network device 10 can know how to convey a set of capabilities supported by a terminal device 50 to the second device 20.

Optionally, the communication network 100 is a wireless network, the capabilities supported by terminal devices 50 can be radio related capabilities during paging procedures; and/or radio related capabilities during procedures except paging.

Optionally, the communication network 100 is a 5G system, the feature of assigning an identifier to represent a set of capabilities supported by a terminal device can be UE radio capability signalling optimisation (RACS).

Optionally, the first network device 10 may implement an AMF, the second network device 20 is in a Radio Access Network RAN, such as an NG-RAN node. When the NG-RAN node connects to the AMF, the first indication can be included in an NG SETUP Request.

Optionally, the first network device 10 may be an MME, the second network device 20 may be an eNB. When the eNB connects to the MME, the first indication can be included in an S1 SETUP REQUEST, or when the eNB updates its configuration, the first indication can be included in an ENB CONFIGURATION UPDATE.

Optionally, the first network device 10 implements a source AMF, the second network device 20 implements a target AMF, the first indication can be sent from the target AMF to the source AMF in a message “Namf_Communication_UEContextTransfer”.

Optionally, the first network device 10 is a source MME, the second network device 20 is a target MME, the first indication may be stored in the source MME.

Optionally, the first network device 10 implements an AMF, the second network device 20 is an MME, the first indication may be stored in the AMF.

Optionally, the first network device 10 is an MME, the second network device 20 implements an AMF, the first indication may be stored in the MME.

Optionally, the first network device 10 may acquire the first indication from the second device 20, or store the first indication in advance, or acquire from a third network device 30 in the wireless communication network 100. Optionally, for a 5G system, the third network device 30 can implement an NRF. Optionally, there might not be in the first network device 10 a whole list of first indication of all the second devices 20 in the communication network 100, once receiving a first indication, the first network device 10 may store the received first indication in correlation with the second network device 20 sending the first indication. Then as time passes by, the first network device 10 may store a number of first indications, wherein each first indication is in correlation with a second network 20.

If the first indication indicates that the second network device 20 supports the feature, the first network device 10 can in a dedicated message for a specific terminal device 50, send the identifier of the set of capabilities supported by the specific terminal device 50 to the second network device 20. Here a “dedicated” message may be a message just involving the specific terminal device 50, such as “Namf_Communication_CreateUEContext request” and “Namf_Communication_UEContextTransfer response” from an AMF, or “Initial Context Setup Request” from an AMF or an MME, etc.

If the first indication indicates that the second network device 20 does not support the feature, the first network device 10 may in a dedicated message for a specific terminal device 50, send the set of capabilities supported by the specific terminal device 50 to the second network device 20.

Optionally, sometimes, although the first indication indicates that the second network device 20 supports the feature, when the first network device 10 sends an identifier of a set of capabilities supported by a terminal device 50 to the second network device 20, the second network device 20 may not have the set of capabilities identified by the identifier. The second network device 20 may further request the first network device 10 for the set of capabilities identified by the identifier. If the first network device 10 stores the set of capabilities, it can send directly to the second network device 20; otherwise, it can further acquire the set of capabilities from a fourth network device 40 in the wireless communication network 100 and send the acquired set of capabilities to the second network device 20. This can also be applicable to the case that the second network device 20 does not support the feature and the first network device 10 does not store the set of capabilities, the first network device 10 can also acquire from the fourth network device 40. Optionally, for a 5G system, the fourth network device 40 can implement a UCMF.

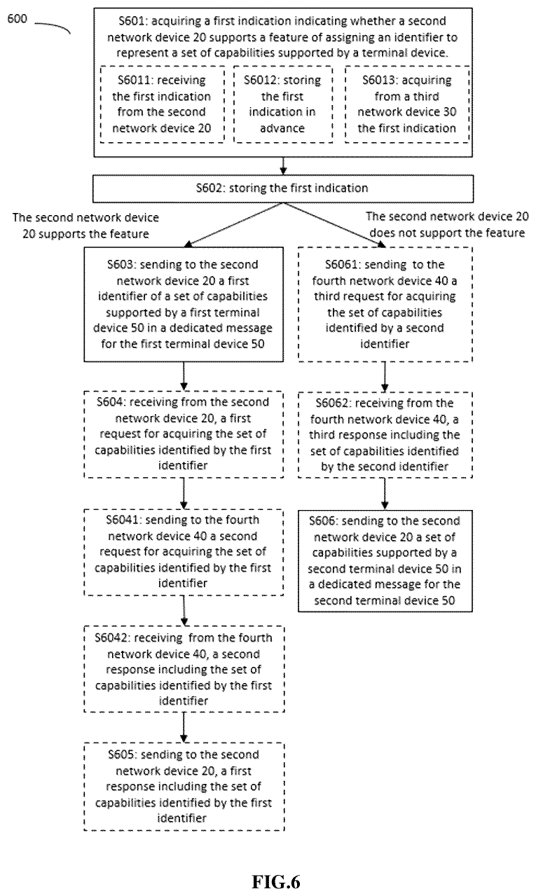

FIG. 5 is a schematic signalling chart illustrating a method 500 with interactions between network devices according to an embodiment of the present disclosure.

In step S501, the first network device 10 may acquire a first indication indicating whether a second network device 20 supports a feature of assigning an identifier to represent a set of capabilities supported by a terminal device 50.

There are 3 optional ways that the first network device 10 can acquire the first indication:

i) in sub step S5011, the first network device 10 can receive the first indication from the second network device 20. Optionally, the first network device 10 can receive the first indication in an existing message with the second network device 20, that is, the message is not a new added one dedicated for transmitting the first indication. For example, when the second network device 20 connects the first network device 10, or the second network device 20 updates its configuration with the first network device 10, there are usually different kinds of information about the second network device 20 to be sent to the first network device 10. The first indication then can be added in an existing message and sent to the first network device 10, which will not involve new signalling. Optionally, when the second network device 20 connects to the first network device 10 the first time, it may via the step S5011 send the first indication to the first network device 10; or maybe the second network device 20 does not support the feature originally, however, after configuration update or software upgrade, it may support the feature now, then the second network device 20 may via the step S5011 to inform the first network device 10 that it can support the feature now. Then the first network device 10 can further send identifiers of sets of capabilities supported by terminal devices 50 instead of the detailed information of capabilities.

ii) in sub step S5012, the first network device 10 may store the first indication in advance.

iii) in the sub step S5011′, for a 5G system, the second network device 20 may send the first indication to the third network device 30 during a service operation of NFRegister. For example, an AMF as a second network device 20 may send a message “Nnrf_NFManagement NFRegister” including the first indication to an NRF. In sub step S5013, the first network device 10 may acquire the first indication of the second network device 20 from the third network device 30. For a 5G system, an AMF can acquire the first indication from an NRF through an NF Discovery procedure. For example, a source AMF can acquire a target AMF's profile through NF Discovery procedure, the first indication can be included in the NF profile.

Optionally, after acquiring the first indication in the step S501, in the step S502, the first network device 10 may further store the first indication for future use. Next time when there is a requirement to convey a terminal device 50's set of capabilities to the second network device 20, the first network device 10 can refer to the stored first indication of the second network device 20 to decide whether to send an identifier or a set of capabilities.

When there is a need to let the second network device 20 know the set of capabilities of a specific terminal device 50, then depending on the first indication, the first network device 10 may proceed differently. For example, for a 5G system, when a UE in Connection Management (CM)-IDLE state initiates a Service Request procedure in order to send uplink signalling messages, the AMF will let NG-RAN, as a second network device 20, know the set of capabilities of the specific terminal device 50.

As shown in FIG. 5, there are two scenarios:
i) the first indication indicates the second network device 20 supports the feature;
ii) the first indication indicates the second network device 20 does not support the feature.

In the scenario i), the first network device 10 may further proceed with step S503, and optionally with steps S504, S5041, S5042 and S505. In the scenario ii), the first network device 10 may further proceed with step S506, and optionally with S5061 and S5062.

### Scenario i) the Second Network Device 20 Supports the Feature

For the scenario i) wherein the second network device 20 supports the feature, in the step S503, in a dedicated message for a first terminal device 50, the first network device 10 may send to the second network device 20 a first identifier of a set of capabilities supported by the first terminal device 50.

After receiving the first identifier in the step S503, the second network device 20 may in the step S503′, determine whether having the set of capabilities identified by the first identifier.

The second network device 20 may not store all the identifiers and corresponding sets of capabilities supported by terminal devices 50. Once receiving an identifier, if the identifier is not stored before and/or the corresponding set of capabilities are not stored before, the second network device 20 may store the received identifier in correlation with the corresponding set of capabilities. Then as time passes by, the second network device 20 may store a number of identifiers and corresponding sets of capabilities. So, it is possible that when receiving the first identifier, the second network device 20 may not have the corresponding set of capabilities.

If not having the set of capabilities identified by the first identifier, the second network device 20 may proceed with the step S504 by sending to the first network device 10, a first request for acquiring the set of capabilities identified by the first identifier.

After receiving the first request, the first network device 10 may determine whether it stores the set of capabilities identified by the first identifier, if it stores, the first network device 10 may in response to the first request send a first response to the second network device 20, including the set of capabilities identified by the first identifier in the first response.

However, sometimes, the first network device 10 may only store identifiers of sets of capabilities supported by terminal devices 50, not store corresponding sets of capabilities. In such a case, if the first network device 10 determines that it does not store the set of capabilities, it may further in step S5041, send to the fourth network device 40 a second request for acquiring the set of capabilities identified by the first identifier; and in step S5042, the first network device 10 may receive from the fourth network device 40, a second response including the set of capabilities identified by the first identifier.

Then in step S505, the first network device 10 may in response to the first request, send the set of capabilities identified by the first identifier to the second network device 20.

Scenario ii) the Second Network Device 20 does not Support the Feature

For scenario ii), in the step S501, the first network device 10 knows based on the first indication that second network device 20 does not support the feature of assigning an identifier to represent a set of capabilities supported by a terminal device. So, in a dedicated message for a specific terminal device 50, the first network device 10 may determine to send the set of capabilities supported by the specific terminal device 50. If the first network device 10 stores the set of capabilities, it may directly send it to the second network device 20, just as shown in FIG. 5, in step S506, in a dedicated message for a second terminal device 50, the first network device 10 may send to the second network device 20 a set of capabilities supported by the second terminal device 50.

However, as mentioned above, the first network device 10 may not store sets of capabilities supported by the second terminal device 50. In such a case, it may further in step S5061, send to the fourth network device 40 a third request for acquiring the set of capabilities identified by a second identifier, wherein the second identifier identifies the set of capabilities supported by the second terminal device 50. And in step S5062, it may further receive a third response including the set of capabilities identified by the second identifier. The first network device 10 can get the set of capabilities and in the step S506 send to the second network device 20.

FIG. 6 is a flowchart illustrating a method 600 performed by a first network device 10 according to an embodiment of the present disclosure.

In step S601, the first network device 10 may acquire a first indication indicating whether a second network device 20 supports a feature of assigning an identifier to represent a set of capabilities supported by a terminal device 50.

Optionally, the step S601 may include following sub steps S6011, S6012 or S6013.

In the sub step S6011, the first network device 10 may receive from the second network device 20 the first indication. Optionally, in the sub step S6011 the first network device 10 may receive from the second network device 20, the first indication in an existing message with the second network device 20.

In the sub step S6012, the first network device 10 may store the first indication in advance.

In the sub step S6013, the first network device 10 may acquire from a third network device 30 storing the second network device 20's supporting features the first indication.

Optionally, in step S602, the first network device 10 may further store the first indication. If the first network device 10 stores the first indication in advance in the sub step S6012, the step S602 may be omitted.

As mentioned above, there are two scenarios:
i) the first indication indicates the second network device 20 supports the feature;
ii) the first indication indicates the second network device 20 does not support the feature.

### Scenario i) the Second Network Device 20 Supports the Feature

For scenario i), the method 600 may further include steps S603, S604, S6041, S6042, S605.

Optionally, in the step S603, if the first indication indicates the second network device 20 supports the feature, the first network device 10 may further send to the second network device 20 a first identifier of a set of capabilities supported by a first terminal device 50 in a dedicated message for the first terminal device 50.

Optionally, after the step S603, in the step S604, the first network device 10 may further receive from the second network device 20, a first request for acquiring the set of capabilities identified by the first identifier. And in step S605, the first network device 10 may further send to the second network device 20, a first response including the set of capabilities identified by the first identifier.

Optionally, after the step S604 and before the step S605, in the step S6041, the first network device 10 may further send to the fourth network device 40 a second request for acquiring the set of capabilities identified by the first identifier; and in the step S6042, the first network device 10 may further receive from the fourth network device 40, a second response including the set of capabilities identified by the first identifier.

Scenario ii) the Second Network Device 20 does not Support the Feature

For scenario ii), the method 600 may further include step S6061, S6062 and S606.

Optionally, in the step S606, if the first indication indicates the second network device 20 does not support the feature, the first network device 10 may send to the second network device 20, a set of capabilities supported by a second terminal device 50 in a dedicated message for the second terminal device 50.

Optionally, before the step S606, in the step S6061, the first network device 10 may send to the fourth network device 40 a third request for acquiring the set of capabilities identified by a second identifier, wherein the second identifier identifies the set of capabilities supported by the second terminal device 50; and in the step S6062, the first network device 10 may receive from the fourth network device 40, a third response including the set of capabilities identified by the second identifier.

Other options of the method 600 can be referred to the steps performed by the first network device in the above mentioned method 500 and other optional implementations in the above mentioned communication network 100.

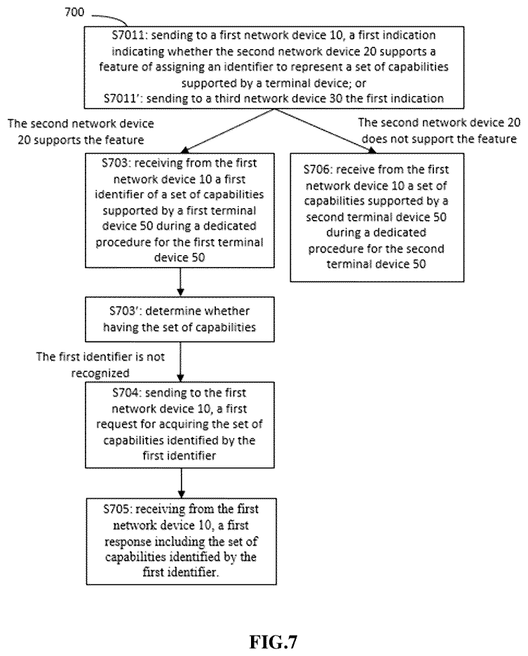

FIG. 7 is a flowchart illustrating a method 700 performed by a second network device 20 according to an embodiment of the present disclosure.

In step S7011, the second network device 20 may send to a first network device 10, a first indication indicating whether the second network device 20 supports a feature of assigning an identifier to represent a set of capabilities supported by a terminal device 50. Optionally, the second network device 20 may send the first indication in an existing message with the first network device 10; or in step S7011′, the second network device 20 may send to the third network device 30 the first indication.

As mentioned above, there are two scenarios:
i) the first indication indicates the second network device 20 supports the feature;
ii) the first indication indicates the second network device 20 does not support the feature.

### Scenario i) the Second Network Device 20 Supports the Feature

For scenario i), the method 700 may further include steps S703, S703′, S704 and S705.

Optionally, in the step S703, the second network device 20 may further receive from the first network device 10 a first identifier of a set of capabilities supported by a first terminal device 50 in a dedicated message for the first terminal device 50.

Optionally, in the step S703′, the second network device 20 may determine whether having the set of capabilities identified by the first identifier.

If not having the set of capabilities identified by the first identifier, in the step S704, the second network device 20 may further send to the first network device 10, a first request for acquiring the set of capabilities identified by the first identifier; in the step S705, the second network device 20 may further receive from the first network device 10, a first response including the set of capabilities identified by the first identifier.

Scenario ii) the Second Network Device 20 does not Support the Feature

For scenario ii), optionally in the step S706, the second network device 20 may further receive from the first network device 10 a set of capabilities supported by a second terminal device 50 in a dedicated message for the second terminal device 50.

Other options of the method 700 can be referred to the steps performed by the second network device 20 in the above mentioned method 500 and optional implementations in the above mentioned communication network 100.

Next, support of RACS is taken as an example in the following embodiments to further introduce the solution provided in the present disclosure and explain technical advantages thereof. 2 use cases are described, use case 1 is about an AMF's indication of its capability to another AMF and use case 2 is about an NG-RAN's indication of its capability to an AMF.

### Use Case 1. AMF's Indication of its Capability to Another AMF

Currently, support of RACS by AMFs are usually configured in a Public Land Mobile Network (PLMN). However, the actual situation is that not all the AMFs support RACS. During a handover procedure between AMFs, a target AMF is usually discovered dynamically via an NRF. And set of capabilities supported by a UE should be informed to the target AMF during the handover procedure. However, the dynamic discovery procedure via NRF cannot ensure a target AMF supporting RACS to be discovered. If an identifier of a set of capabilities supported by a UE is sent directly from a source AMF to a target AMF, the identifier will be ignored, and a message may be triggered for the target AMF to acquire the set of capabilities from the involved terminal device. With the solution provided in the present disclosure, whether the target AMF supports RACS can be in advance indicated to the source AMF, either by indication from the NRF in a discovery procedure, or during the registration procedure, by indication from the target AMF to the source AMF.

### Embodiment 1. Information Indication Between AMFs During a Handover Procedure

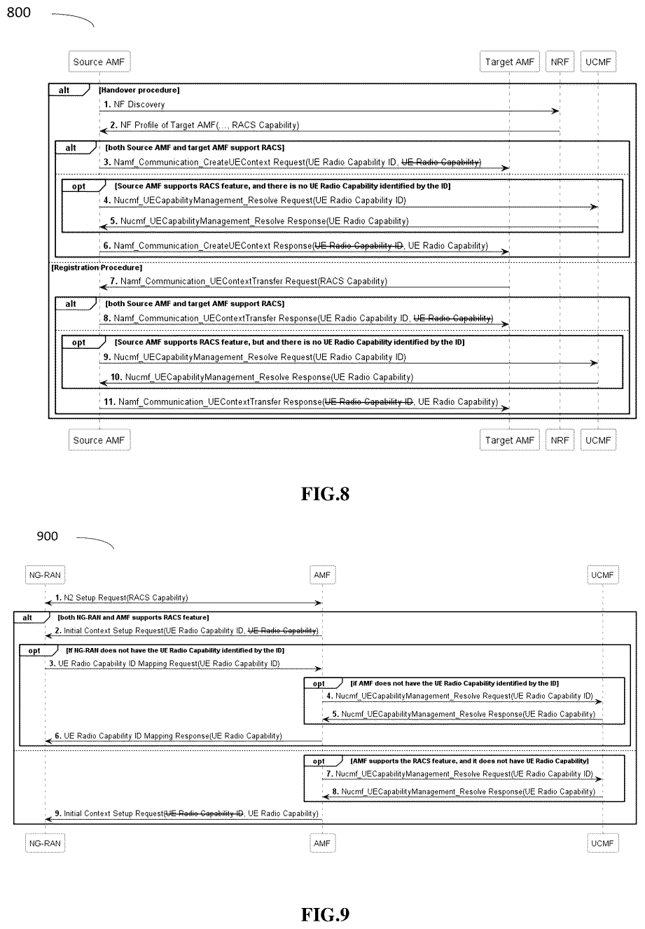

Referring to steps 1 to 6 in FIG. 8, in step 1, a source AMF may initiate an NF Discovery procedure towards an NRF, and in step 2, get an NF Profile of a Target AMF, with the first indication (RACS Capability) included. To be noted that, in FIG. 8 and FIG. 9, “alt” means that an alternative procedure is being introduced; “opt” means that the enclosed steps are optional; dotted lines are used to separated different procedures.

Then for the case that both the source AMF and the target AMF support RACS, in step 3, the source AMF may send in the message Namf_Communication_CreateUEContext Request, UE Radio Capability ID (an example of the first identifier) instead of UE Radio Capability (an example of a set of capabilities supported by a terminal device 50, and struck through in FIG. 8).

And for the case that the source AMF supports RACS, while the target AMF does not, and the source AMF may only store the UE Radio Capability ID, not store the corresponding UE Radio capability, the source AMF may first acquire the UE Radio Capability and then send to the target AMF. In step 4, the source AMF may send a message Nucmf_UECapabilityManagement_Resolve Request carrying the UE Radio Capability ID to a UCMF (as a fourth network device 40), and in step 5, receive from the UCMF a message Nucmf_UECapabilityManagement_Resolve Response including the UE Radio Capability, then in step 6, it may send a message Namf_Communication_CreateUEContext Response including UE Radio Capability instead of UE Radio Capability ID, as struck through in FIG. 8.

### Embodiment 2. Information Indication Between AMFs During a Registration Procedure

Referring to steps 7 to 11 in FIG. 8, in step 7, the target AMF may send a message Namf_Communication_UEContextTransfer Request, including RACS capability (i.e. the first indication).

If both the source AMF and the target AMF support RACS, in step 8, the source AMF may send a message Namf_Communication_UEContextTransfer Response including the UE Radio Capability ID instead of the UE Radio Capability, as struck through in FIG. 8.

If the source AMF supports RACS but the target AMF does not support and the source AMF does not store the UE Radio Capability corresponding to the UE Radio Capability ID, it may in step 9, send a message Nucmf_UECapabilityManagement_Resolve Request carrying the UE Radio Capability ID to a UCMF (as a fourth network device 40), and in step 10, receive from the UCMF a message Nucmf_UECapabilityManagement_Resolve Response including the UE Radio Capability, then in step 11, it send a message Namf_Communication_UEContextTransfer Response including UE Radio Capability instead of UE Radio Capability ID, as struck through in FIG. 8.

In embodiment 1, an AMF (as a second network device 20) may include RACS in the supportedFeatures in the NFService registered in an NRF (an example of the above mentioned step S5011′ and S7011′); in embodiment 2, a target AMF may include RACS in the supportedFeatures provided in the Namf_Communication service operation. For use case 1, in both embodiment 1 and 2, the capability of an AMF (i.e. the first indication) can be detected by the peer AMF. If both source AMF and target AMF support RACS feature, then the source AMF can only transfer the UE Radio Capability ID, and without UE Radio Capabilities.

The “SupportedFeatures” may indicate all the features supported an AMF, and it can be implemented as a bit string, as defined in Table 5.2.2-1: Simple Data Types in 3GPP TS 29.571 v18.1.0 (2023-03): “The string shall contain a bitmask indicating supported features in hexadecimal representation: Each character in the string shall take a value of “0” to “9”, “a” to “f” or “A” to “F” and shall represent the support of 4 features as described in table 5.2.2-3. The most significant character representing the highest-numbered features shall appear first in the string, and the character representing features 1 to 4 shall appear last in the string. The list of features and their numbering (starting with 1) are defined separately for each API. If the string contains a lower number of characters than there are defined features for an API, all features that would be represented by characters that are not present in the string are not supported.” RACS can be added as one bit in the bit string, optionally, “1” indicates that an AMF supports RACS, “0” indicates that an AMF does not support RACS.

For embodiment 2, as defined in clause 6.1.8 in 3GPP TS 29.518 v18.1.0 (2023-03), “the feature negotiation mechanism specified in clause 6.6 of 3GPP TS 29.500 shall be used to negotiate the optional features applicable between the AMF and the NF Service Consumer, for the Namf_Communication service, if any. The NF Service Consumer shall indicate the optional features it supports for the Namf_Communication service, if any, by including the supportedFeatures attribute in payload of the HTTP Request Message for following service operations:
N1N2MessgeTransfer, as specified in clause 5.2.2.3.1;
N1N2MessageSubscribe, as specified in clause 5.2.2.3.3;
NonUeN2InfoSubscribe, as specified in clause 5.2.2.4.2;
UeContextTransfer, as specified in clause 5.2.2.2.1;
CreateUEContext, as specified in clause 5.2.2.2.3

The AMF shall determine the supported features for the service operations as specified in clause 6.6 of 3GPP TS 29.500 and shall indicate the supported features by including the SupportedFeatures attribute in payload of the HTTP response for the service operation.

The syntax of the SupportedFeatures attribute is defined in clause 5.2.2 of 3GPP TS 29.571 V18.1.0 (2023-03).”

Features are defined for the Namf_Communication service in the Table 6.1.8-1: Features of supportedFeatures attribute used by Namf_Communication service in 3GPP TS 29.518 V18.1.0 (2023-03):

TABLE 6.1.8-1
Features of supportedFeatures attribute used by Namf_Communication service

| Feature | | | |
|---|---|---|---|
| Number | Feature | M/O | Description |
| 1 | DTSSA | O | Deployments Topologies with specific SMF Service Areas. |
| | | | An AMF that supports this feature shall support the procedures specified in |
| | | | clause 5.34 of 3GPP TS 23.501 [2] and in clause 4.23 of 3GPP TS 23.502 [3]. |
| 2 | ENS | O | This feature bit indicates whether the AMF supports procedures related to |
| | | | Network Slicing (see 3GPP TS 23.501 [2] clause 5.15.7). This includes |
| | | | supporting the RelocateUEContext service operation (see clause 5.2.2.2.5). |
| 3 | CIOT | O | Cellular IoT |
| | | | Support of this feature implies the support of all the CIoT features specified in |
| | | | clause 5.31 of 3GPP TS 23.501 [2], including in particular corresponding |
| | | | service's extensions to support: |
| | | | NB-IoT and LTE-M RAT types; |
| | | | Control Plane CIoT 5GS Optimisation; |
| | | | Rate control of user data. |
| 4 | MAPDU | O | This feature bit indicates whether the AMF supports Multi-Access PDU session |
| | | | procedures related to Access Traffic Steering, Switching and Splitting (see |
| | | | clauses 4.2.10 and 5.32 of 3GPP TS 23.501 [2]). |
| 5 | NPN | O | Non-Public Network |
| | | | Support of this feature implies support of NPN information and receipt of a |
| | | | Create UE context error response with a binary part during an Inter-AMF N2 |
| | | | Handover. |
| 6 | ELCS | O | This feature indicates supports of enhanced LCS, including the capability for |
| | | | the AMF to send an LCS message through the target access type requested |
| | | | by the LMF. |
| 7 | ES3XX | M | Extended Support of HTTP 307/308 redirection |
| | | | An NF Service Consumer (e.g. SMF) that supports this feature shall support |
| | | | handling of HTTP 307/308 redirection for any service operation of the |
| | | | Namf_Communication service. An NF Service Consumer that does not support |
| | | | this feature does only support HTTP redirection as specified for 3GPP |
| | | | Release 15. |
| 8 | EAEA | O | EBI and ARP mapping update in EBIAssignment |
| | | | Support of this feature implies support of updating the mapping of EBI and |
| | | | ARP in EBIAssignment for a QoS flow to which an EBI is already allocated. |
| 9 | ProSe | O | This feature indicates the support of UE policy and N2 information provisioning |
| | | | for 5G ProSe. |
| 10 | UAV | O | Uncrewed Aerial Vehicle |
| | | | This feature indicates the support of UAV feature at AMF. When this feature is |
| | | | supported at the AMF, the AMF shall perform the UUAA-MM procedure |
| | | | defined in 3GPP TS 23.256 [56]. |
| 11 | SPAE | O | SM Policy Association Events |
| | | | This feature bit indicates whether the AMF supports the SM Policy Association |
| | | | establishment and termination event notification information handling, i.e. |
| | | | whereby the PCF for UE subscribes to SM Policy Association events to the |
| | | | PCF for SM Policy via the AMF and SMF, as specified in clause 4.3.2.2.1 and |
| | | | clause 4.3.3.2 of 3GPP TS 23.502 [3]. |
| 12 | eNPN | O | Enhanced support of Non-Public Networks (eNPN) |
| | | | This feature indicates the AMF supports UE registration for onboarding in an |
| | | | SNPN, see clause 5.30.2.10.2.6 and clause 5.30.2.10.2.7 in |
| | | | 3GPP TS 23.501 [2]). |
| 13 | 3GA- | O | Handover between 3GPP and non-3GPP accesses |
| | N3GA-HO | | An AMF and SMF that supports Handover between 3GPP and non-3GPP |
| | | | accesses shall support this feature, i.e. setting the targetAccess IE in |
| | | | N1N2MessageTransfer Request to the old access type when releasing the N2 |
| | | | PDU session resources in the old access (see clauses 5.2.2.3.1.1 and |
| | | | 6.1.6.2.18) |
| x | RACS | O | Support of RACS feature as specified in clause 5.4.4.1a in |
| | | | 3GPP TS 23.501 [2]). |
| | | | During an Inter AMF mobility procedure, the source AMF may determine to not |
| | | | include ueRadioCapability and ueRadioCapabilityForPaging in the |
| | | | UeContextTransferRspData or UeContextCreateData if the target AMF |
| | | | supports RACS feature, so to retrieve the same using RACS Id(s) included in |
| | | | the MM Context. |

Feature number: The order number of the feature within the supportedFeatures attribute (starting with 1).
Feature: A short name that can be used to refer to the bit and to the feature.
M/O: Defines if the implementation of the feature is mandatory (“M”) or optional (“O”).
Description: A clear textual description of the feature.

In the above table, feature “RACS” (the last underlined line in the table) as the new added feature in the embodiment 2, indicate whether an AMF supports the feature RACS.

The embodiments are also applicable to UE Radio Capability for Paging (an example of the feature of assigning an identifier to represent a set of capabilities supported by a terminal device).

### Use Case 2. NG-RAN's Indication of its Capability to an AMF

Currently, as defined in 3GPP TS 38.413 V17.4.0 (2023-03), there isn't a mechanism for an AMF to know whether a connected NG-RAN supports RACS. Usually, there are two operations an AMF can have:

Operation 1. Detecting whether a NG-RAN supports RACS based on assigned criticality.

As mentioned above, an AMF supporting RACS will directly include the UE Radio Capability ID (as shown in the following table) in an N2 message (e.g. Initial Context Setup Request) for the first UE serving by this NG-RAN. If the NG-RAN does not support the RACS feature, it shall reject the request with the criticality diagnostics in the response. Then the AMF can know and remember the RACS capability based on that, and will not include UE Radio Capability ID in the subsequent N2 messages. The AMF will retry the N2 message for this UE without the UE Radio Capability ID.

| | | | | |
|---|---|---|---|---|
| UE Radio Capability ID | O | 9.3.1.142 | YES | reject |

So, the impact to the UE can be limited to the first UE trying to establish the user plane. However, usually there may be thousands of NG-RAN connected to the same AMF, the corresponding message detection has to be performed for all NG-RANs.

Operation 2. An AMF always only include UE Radio Capabilities to the NG-RAN if available without the UE Radio Capability ID, even for the NG-RAN node which supports RACS, which is against the purpose of RACS feature as well, i.e. no signalling optimization for UE Radio Capability between NG-RAN and AMF.

### Embodiment 3. Information Indication by an NG-RAN to an AMF

In embodiment 3, the RACS capability of an NG-RAN (i.e the first indication) can be indicated in message N2 Setup Request or RAN Configuration Update from the NG-RAN (e.g gNodeB).

As shown in FIG. 9, in step 1, an NG-RAN may send a message N2 Setup Request to an AMF, including RACS Capability (i.e. the first indication).

If both the NG-RAN and the AMF support RACS, in step 2, the AMF may send a message Initial Context Setup Request to the NG-RAN, including UE Radio Capability ID.

Optionally, although the NG-RAN supports RACS, it may not have the UE Radio Capability identified by the UE Radio Capability ID, so in step 3, the NG-RAN may send a UE Radio Capability ID Mapping Request to the AMF, including the UE Radio Capability ID, to request the UE Radio Capability identified by the UE Radio Capability ID.

Optionally, the AMF may not have the UE Radio Capability identified by the UE Radio Capability ID either, it may in step 4, send a message Nucmf_UECapabilityManagement_Resolve Request including the UE Radio Capability ID to a UCMF and in step 5, receive from the UCMF a message Nucmf_UECapabilityManagement_Resolve Response including the UE Radio Capability. Then in step 6, the AMF may send the received UE Radio Capability to the NG-RAN in a message UE Radio Capability ID Mapping Response instead of UE Radio Capability ID, as struck through in FIG. 9.

If the AMF supports RACS but the NG-RAN does not support RACS, and optionally the AMF may not have UE Radio Capability corresponding to the UE Radio Capability ID, it may in step 7, send a message Nucmf_UECapabilityManagement_Resolve Request including the UE Radio Capability ID to a UCMF and in step 8, receive from the UCMF a message Nucmf_UECapabilityManagement_Resolve Response including the UE Radio Capability. Then in step 9, the AMF may send a message Initial Context Setup Request to the NG-RAN including the received UE Radio Capability instead of UE Radio Capability ID, as struck through in FIG. 9.

In embodiment 3, dynamic RACS capability detection with Interface Management messages from the NG-RAN, i.e. NG Setup Request, RAN configuration Update. RACS capability will be reported by the NG-RAN, so the AMF will know the RACS capability of NG-RAN. If both support RACS, then only UE Radio Capability ID need to be transferred in the N2 messages (e.g Initial Context Setup Request, or UE Capability Match Request), without UE Radio Capability.

Embodiment 3 can also be applied between eNodeB and MME in Evolved Packet System (EPS) as well.

In the NG SETUP REQUEST or RAN CONFIGURATION UPDATE as defined in clause 9.2.6 in 3GPP TS 38.413 V17.4.0 (2023-03), a new Information Element (IE) “RACS Indication” can be added as the first indication (the last underlined line in the following table):

| | | | IE type and | Semantics | | Assigned |
|---|---|---|---|---|---|---|
| IE/Group Name | Presence | Range | reference | description | Criticality | Criticality |
| . . . | . . . | . . . | . . . | . . . | . . . | . . . |
| >>>>TAI NSAG | O | | 9.3.1.238 | NSAG information | YES | ignore |
| Support List | | | | associated with the | | |
| | | | | slices per TAC, per | | |
| | | | | PLMN or per | | |
| | | | | SNPN. | | |
| >>>>RACS | O | | ENUMERATED | Indication of RACS | YES | ignore |
| Indication | | | (true, . . . ) | support | | |

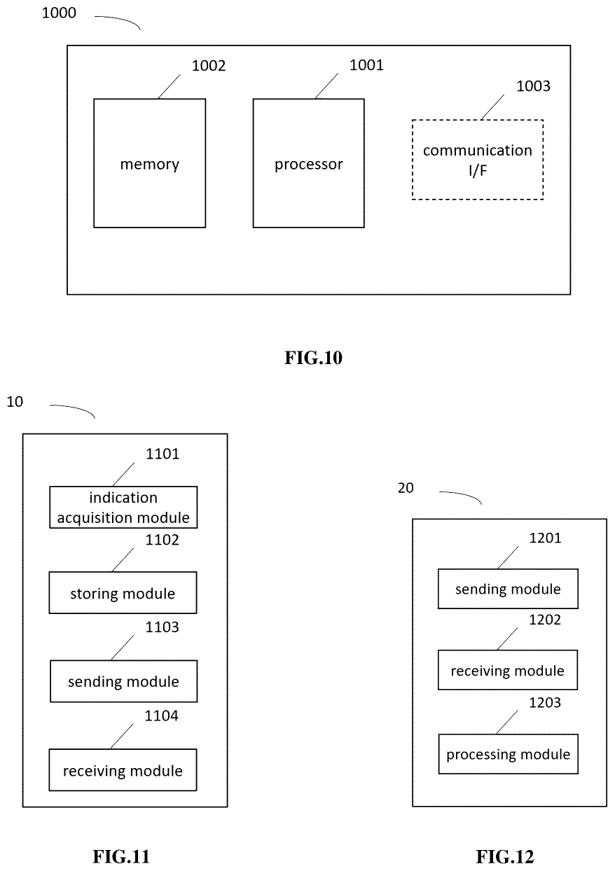

FIG. 10 is a block diagram illustrating an apparatus suitable for use in practicing some embodiments of the present disclosure. For example, the first network device 10 and the second network device 20 described above can be implemented through the apparatus 1000. As shown, the apparatus 1000 can include at least one processor 1001, at least one memory 1002 that stores a program, and optionally a communication interface 1003 for communicating data with external devices.

The program includes program instructions that, when executed by the at least one processor 1001, enable the apparatus 1000 to operate in accordance with the embodiments of the present disclosure, as discussed above. That is, the embodiments of the present disclosure can be implemented at least in part by computer software executable by the at least one processor 1001, or by hardware, or by a combination of software and hardware.

The memory 1002 can be of any type suitable to the local technical environment and can be implemented using any suitable data storage technology, such as semiconductor based memory devices, flash memories, magnetic memory devices and systems, optical memory devices and systems, fixed memories and removable memories. The processor 1001 can be of any type suitable to the local technical environment, and can include one or more of general purpose computers, special purpose computers, microprocessors, digital signal processors (DSPs) and processors based on multi-core processor architectures, as non-limiting examples.

FIG. 11 is a block diagram illustrating a first network device 10 according to an embodiment of the present disclosure. As shown in FIG. 11, a first network device 10 may comprise an indication acquisition module 1101, configured to acquire a first indication indicating whether a second network device 20 supports a feature of assigning an identifier to represent a set of capabilities supported by a terminal device.

Optionally, when acquiring the first indication the indication, indication acquisition module 1101 is further configured to receive, from the second network device 20, the first indication; or store the first indication; or acquire, from a third network device 30 storing information of the second network device 20's supporting features, the first indication.

Optionally, when receiving from the second network device 20 the first indication, the indication acquisition module 1101 is further configured to receive from the second network device 20 the first indication in an existing message with the second network device 20.

Optionally, the first network device 10 may further comprise a storing module 1102, configured to store the first indication.

Optionally, the first network device 10 may further comprise a sending module 1103, configured to send to the second network device 20 a first identifier of a set of capabilities supported by a first terminal device if the first indication indicates the second network device 20 supports the feature.

Optionally, the first network device 10 may further comprise a receiving module 1104, configured to receive from the second network device 20 a first request for acquiring the set of capabilities identified by the first identifier. The sending module 1103 is further configured to send to the second network device 20 a first response including the set of capabilities identified by the first identifier.

Optionally, after the receiving module 1104 receives from the second network device 20 a first request for acquiring the set of capabilities identified by the first identifier and before the sending module 1103 sends to the second network device 20 a first response including the set of capabilities identified by the first identifier, the sending module 1103 is further configured to send to a fourth network device 40 storing identifiers and corresponding sets of capabilities supported by terminal devices identified by each identifier a second request for acquiring the set of capabilities identified by the first identifier; and the receiving module 1104 is further configured to receive from the fourth network device 40 a second response including the set of capabilities identified by the first identifier.

Optionally, the sending module 1103 is further configured to: if the first indication indicates the second network device 20 does not support the feature, send to the second network device 20 a set of capabilities supported by a second terminal device.

Optionally, before the sending module 1103 sends to the second network device 20, a set of capabilities supported by a second terminal, the sending module 1103 is further configured to send to a fourth network device 40 storing identifiers and corresponding sets of capabilities supported by terminal devices identified by each identifier a third request for acquiring the set of capabilities identified by a second identifier, wherein the second identifier identifies the set of capabilities supported by the second terminal device; and the receiving module 1104 is further configured to receive from the fourth network device 40 a third response including the set of capabilities identified by the second identifier.

Other optional implementation can be referred to above mentioned description on the first network device 10.

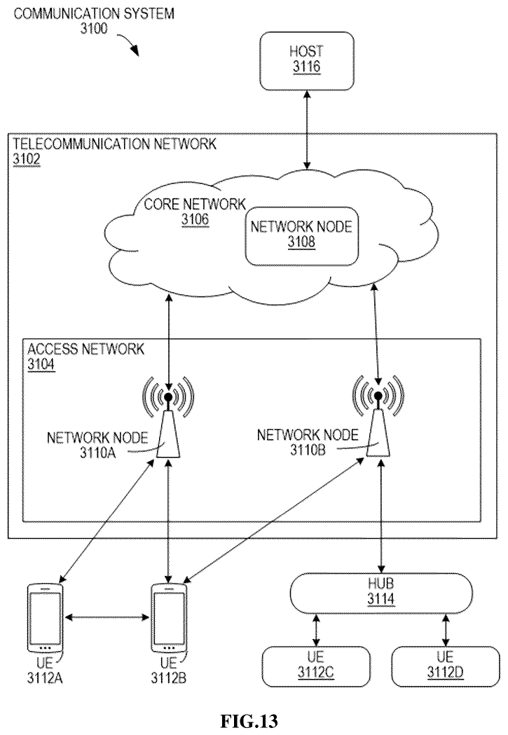

FIG. 12 is a block diagram illustrating a second device according to an embodiment of the present disclosure. As shown in FIG. 12, the second network device 20 may comprise a sending module 1201, configured to send to a first network device 10, a first indication indicating whether the second network device 20 supports a feature of assigning an identifier to represent a set of capabilities supported by a terminal device; or send to a third network device 30 storing the second network device 20's supporting features, the first indication.

Optionally, when sending to a first network device 10 a first indication indicating whether the second network device 20 supports a feature of assigning an identifier to represent a set of capabilities supported by a terminal device, the sending module 1201 is further configured to send to the first network device 10, the first indication in an existing message with the first network device 10.

Optionally, the second network device 20 may further comprise a receiving module 1202, configured to receive from the first network device 10 a first identifier of a set of capabilities supported by a first terminal if the second network device 20 supports the feature.

Optionally, the second network device 20 may further comprise a processing module 1203, configured to determine whether the second network device 20 has of the set of capabilities identified by the first identifier. After the receiving module 1202 receives from the first network device 10 a first identifier of a set of capabilities supported by a first terminal device in a dedicated message for the first terminal device, the sending module 1201 is further configured to send to the first network device 10 a first request for acquiring the set of capabilities identified by the first identifier and the receiving module 1202 is further configured to receive from the first network device 10 a first response including the set of capabilities identified by the first identifier if the second network device 20 does not have the set of capabilities identified by the first identifier.

Optionally, the receiving module 1202 is further configured to receive from the first network device 10, a set of capabilities supported by a second terminal device if the second network device 20 does not support the feature.

Other optional implementation can be referred to above mentioned description on the second network device 20 in the present disclosure.

FIG. 13 shows an example of a communication system 3100 in accordance with some embodiments.

In the example, the communication system 3100 includes a telecommunication network 3102 that includes an access network 3104, such as a radio access network (RAN), and a core network 3106, which includes one or more core network nodes 3108. The access network 3104 includes one or more access network nodes, such as network nodes 3110A and 3110B (one or more of which may be generally referred to as network nodes 3110), or any other similar 3rd Generation Partnership Project (3GPP) access node or non-3GPP access point. The network nodes 3110 facilitate direct or indirect connection of user equipment (UE), such as by connecting UEs 3112A, 3112B, 3112C, and 3112D (one or more of which may be generally referred to as UEs 3112) to the core network 3106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 3100 may include any number of wired or wireless networks, network nodes, UEs, and/or any other components or systems that may facilitate or participate in the communication of data and/or signals whether via wired or wireless connections. The communication system 3100 may include and/or interface with any type of communication, telecommunication, data, cellular, radio network, and/or other similar type of system.

The UEs 3112 may be any of a wide variety of communication devices, including wireless devices arranged, configured, and/or operable to communicate wirelessly with the network nodes 3110 and other communication devices. Similarly, the network nodes 3110 are arranged, capable, configured, and/or operable to communicate directly or indirectly with the UEs 3112 and/or with other network nodes or equipment in the telecommunication network 3102 to enable and/or provide network access, such as wireless network access, and/or to perform other functions, such as administration in the telecommunication network 3102.

In the depicted example, the core network 3106 connects the network nodes 3110 to one or more hosts, such as host 3116. These connections may be direct or indirect via one or more intermediary networks or devices. In other examples, network nodes may be directly coupled to hosts. The core network 3106 includes one more core network nodes (e.g., core network node 3108) that are structured with hardware and software components. Features of these components may be substantially similar to those described with respect to the UEs, network nodes, and/or hosts, such that the descriptions thereof are generally applicable to the corresponding components of the core network node 3108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 3116 may be under the ownership or control of a service provider other than an operator or provider of the access network 3104 and/or the telecommunication network 3102, and may be operated by the service provider or on behalf of the service provider. The host 3116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 3100 of FIG. 13 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 3102 is a cellular network that implements 3GPP standardized features. Accordingly, the telecommunications network 3102 may support network slicing to provide different logical networks to different devices that are connected to the telecommunication network 3102. For example, the telecommunications network 3102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 3112 are configured to transmit and/or receive information without direct human interaction. For instance, a UE may be designed to transmit information to the access network 3104 on a predetermined schedule, when triggered by an internal or external event, or in response to requests from the access network 3104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 3114 communicates with the access network 3104 to facilitate indirect communication between one or more UEs (e.g., UE 3112C and/or 3112D) and network nodes (e.g., network node 31101B). In some examples, the hub 3114 may be a controller, router, content source and analytics, or any of the other communication devices described herein regarding UEs. For example, the hub 3114 may be a broadband router enabling access to the core network 3106 for the UEs. As another example, the hub 3114 may be a controller that sends commands or instructions to one or more actuators in the UEs. Commands or instructions may be received from the UEs, network nodes 3110, or by executable code, script, process, or other instructions in the hub 3114. As another example, the hub 3114 may be a data collector that acts as temporary storage for UE data and, in some embodiments, may perform analysis or other processing of the data. As another example, the hub 3114 may be a content source. For example, for a UE that is a VR headset, display, loudspeaker or other media delivery device, the hub 3114 may retrieve VR assets, video, audio, or other media or data related to sensory information via a network node, which the hub 3114 then provides to the UE either directly, after performing local processing, and/or after adding additional local content. In still another example, the hub 3114 acts as a proxy server or orchestrator for the UEs, in particular in if one or more of the UEs are low energy IoT devices.

The hub 3114 may have a constant/persistent or intermittent connection to the network node 3110b. The hub 3114 may also allow for a different communication scheme and/or schedule between the hub 3114 and UEs (e.g., UE 3112C and/or 3112D), and between the hub 3114 and the core network 3106. In other examples, the hub 3114 is connected to the core network 3106 and/or one or more UEs via a wired connection. Moreover, the hub 3114 may be configured to connect to an M2M service provider over the access network 3104 and/or to another UE over a direct connection. In some scenarios, UEs may establish a wireless connection with the network nodes 3110 while still connected via the hub 3114 via a wired or wireless connection. In some embodiments, the hub 3114 may be a dedicated hub—that is, a hub whose primary function is to route communications to/from the UEs from/to the network node 3110B. In other embodiments, the hub 3114 may be a non-dedicated hub—that is, a device which is capable of operating to route communications between the UEs and network node 3110b, but which is additionally capable of operating as a communication start and/or end point for certain data channels.

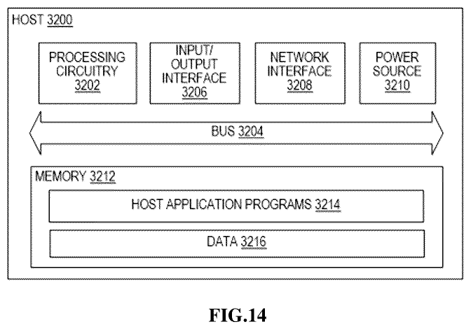

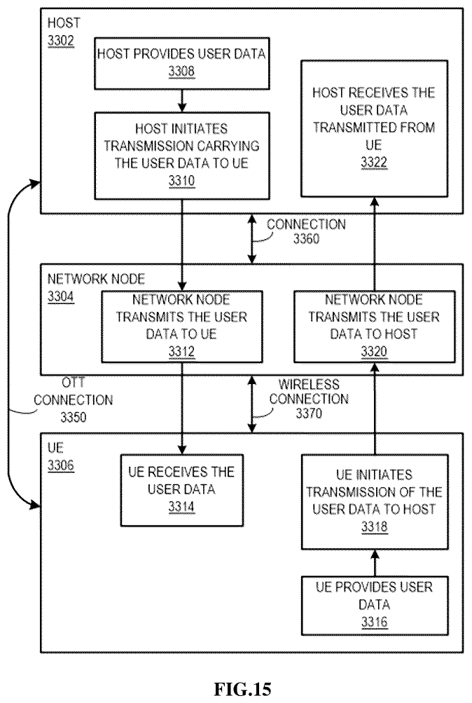

FIG. 14 is a block diagram of a host 3200, which may be an embodiment of the host 3116 of FIG. 17, in accordance with various aspects described herein. As used herein, the host 3200 may be or comprise various combinations hardware and/or software, including a standalone server, a blade server, a cloud-implemented server, a distributed server, a virtual machine, container, or processing resources in a server farm. The host 3200 may provide one or more services to one or more UEs.

The host 3200 includes processing circuitry 3202 that is operatively coupled via a bus 3204 to an input/output interface 3206, a network interface 3208, a power source 3210, and a memory 3212. Other components may be included in other embodiments. Features of these components may be substantially similar to those described with respect to the devices of previous figures such that the descriptions thereof are generally applicable to the corresponding components of host 3200.

The memory 3212 may include one or more computer programs including one or more host application programs 3214 and data 3216, which may include user data, e.g., data generated by a UE for the host 3200 or data generated by the host 3200 for a UE. Embodiments of the host 3200 may utilize only a subset or all of the components shown. The host application programs 3214 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 3214 may also provide for user authentication and licensing checks and may periodically report health, routes, and content availability to a central node, such as a device in or on the edge of a core network. Accordingly, the host 3200 may select and/or indicate a different host for over-the-top services for a UE. The host application programs 3214 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 15 shows a communication diagram of a host 3302 communicating via a network node 3304 with a UE 3306 over a partially wireless connection in accordance with some embodiments. Example implementations, in accordance with various embodiments, of the UE (such as a UE 3112A of FIG. 13), network node (such as network node 3110A of FIG. 13), and host (such as host 3116 of FIG. 13 and/or host 3200 of FIG. 14) discussed in the preceding paragraphs will now be described with reference to FIG. 15.

Like host 3200, embodiments of host 3302 include hardware, such as a communication interface, processing circuitry, and memory. The host 3302 also includes software, which is stored in or accessible by the host 3302 and executable by the processing circuitry. The software includes a host application that may be operable to provide a service to a remote user, such as the UE 3306 connecting via an over-the-top (OTT) connection 3350 extending between the UE 3306 and host 3302. In providing the service to the remote user, a host application may provide user data which is transmitted using the OTT connection 3350.

The network node 3304 includes hardware enabling it to communicate with the host 3302 and UE 3306. The connection 3360 may be direct or pass through a core network (like core network 3106 of FIG. 13) and/or one or more other intermediate networks, such as one or more public, private, or hosted networks. For example, an intermediate network may be a backbone network or the Internet.

The UE 3306 includes hardware and software, which is stored in or accessible by UE 3306 and executable by the UE's processing circuitry. The software includes a client application, such as a web browser or operator-specific “app” that may be operable to provide a service to a human or non-human user via UE 3306 with the support of the host 3302. In the host 3302, an executing host application may communicate with the executing client application via the OTT connection 3350 terminating at the UE 3306 and host 3302. In providing the service to the user, the UE's client application may receive request data from the host's host application and provide user data in response to the request data. The OTT connection 3350 may transfer both the request data and the user data. The UE's client application may interact with the user to generate the user data that it provides to the host application through the OTT connection 3350.

The OTT connection 3350 may extend via a connection 3360 between the host 3302 and the network node 3304 and via a wireless connection 3370 between the network node 3304 and the UE 3306 to provide the connection between the host 3302 and the UE 3306. The connection 3360 and wireless connection 3370, over which the OTT connection 3350 may be provided, have been drawn abstractly to illustrate the communication between the host 3302 and the UE 3306 via the network node 3304, without explicit reference to any intermediary devices and the precise routing of messages via these devices.

As an example of transmitting data via the OTT connection 3350, in step 3308, the host 3302 provides user data, which may be performed by executing a host application. In some embodiments, the user data is associated with a particular human user interacting with the UE 3306. In other embodiments, the user data is associated with a UE 3306 that shares data with the host 3302 without explicit human interaction. In step 3310, the host 3302 initiates a transmission carrying the user data towards the UE 3306. The host 3302 may initiate the transmission responsive to a request transmitted by the UE 3306. The request may be caused by human interaction with the UE 3306 or by operation of the client application executing on the UE 3306. The transmission may pass via the network node 3304, in accordance with the teachings of the embodiments described throughout this disclosure. Accordingly, in step 3312, the network node 3304 transmits to the UE 3306 the user data that was carried in the transmission that the host 3302 initiated, in accordance with the teachings of the embodiments described throughout this disclosure. In step 3314, the UE 3306 receives the user data carried in the transmission, which may be performed by a client application executed on the UE 3306 associated with the host application executed by the host 3302.

In some examples, the UE 3306 executes a client application which provides user data to the host 3302. The user data may be provided in reaction or response to the data received from the host 3302. Accordingly, in step 3316, the UE 3306 may provide user data, which may be performed by executing the client application. In providing the user data, the client application may further consider user input received from the user via an input/output interface of the UE 3306. Regardless of the specific manner in which the user data was provided, the UE 3306 initiates, in step 3318, transmission of the user data towards the host 3302 via the network node 3304. In step 3320, in accordance with the teachings of the embodiments described throughout this disclosure, the network node 3304 receives user data from the UE 3306 and initiates transmission of the received user data towards the host 3302. In step 3322, the host 3302 receives the user data carried in the transmission initiated by the UE 3306.

One or more of the various embodiments improve the performance of OTT services provided to the UE 3306 using the OTT connection 3350, in which the wireless connection 3370 forms the last segment. More precisely, the teachings of these embodiments may improve the data rate and thereby provide benefits such as relaxed restriction on file size, improved content resolution, and better responsiveness.

In an example scenario, factory status information may be collected and analyzed by the host 3302. As another example, the host 3302 may process audio and video data which may have been retrieved from a UE for use in creating maps. As another example, the host 3302 may collect and analyze real-time data to assist in controlling vehicle congestion (e.g., controlling traffic lights). As another example, the host 3302 may store surveillance video uploaded by a UE. As another example, the host 3302 may store or control access to media content such as video, audio, VR or AR which it can broadcast, multicast or unicast to UEs. As other examples, the host 3302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 3350 between the host 3302 and UE 3306, in response to variations in the measurement results.

The measurement procedure and/or the network functionality for reconfiguring the OTT connection may be implemented in software and hardware of the host 3302 and/or UE 3306. In some embodiments, sensors (not shown) may be deployed in or in association with other devices through which the OTT connection 3350 passes; the sensors may participate in the measurement procedure by supplying values of the monitored quantities exemplified above, or supplying values of other physical quantities from which software may compute or estimate the monitored quantities. The reconfiguring of the OTT connection 3350 may include message format, retransmission settings, preferred routing etc.; the reconfiguring need not directly alter the operation of the network node 3304. Such procedures and functionalities may be known and practiced in the art. In certain embodiments, measurements may involve proprietary UE signaling that facilitates measurements of throughput, propagation times, latency and the like, by the host 3302. The measurements may be implemented in that software causes messages to be transmitted, in particular empty or ‘dummy’ messages, using the OTT connection 3350 while monitoring propagation times, errors, etc.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one skilled in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements. It should be noted that two blocks shown in succession in the above figures may, in fact, be executed substantially concurrently, or the blocks may sometimes be executed in the reverse order, depending upon the functionality involved.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1. A method for information indication performed by a first network device, comprising:
acquiring a first indication indicating whether a second network device supports a feature of assigning an identifier to represent a set of capabilities supported by a terminal device; and
sending to the second network device a first identifier of a set of capabilities supported by a first terminal device instead of the set of capabilities supported by the first terminal device, if the first indication indicates the second network device supports the feature.

2. The method according to claim 1, wherein acquiring the first indication further comprises:
receiving, from the second network device, the first indication;
storing the first indication in advance; or
acquiring, from a third network device storing the second network device supporting features, the first indication.

3. The method according to claim 2, wherein receiving, from the second network device, the first indication, further comprises:
receiving, from the second network device, the first indication in an existing message.

4. The method according to claim 1, further comprising:
storing the first indication.

5. The method according to claim 1, after sending, to the second network device, a first identifier of a set of capabilities supported by a first terminal device, further comprising:
receiving, from the second network device, a first request for acquiring the set of capabilities identified by the first identifier; and
sending, to the second network device, a first response including the set of capabilities identified by the first identifier.

6. The method according to claim 5, after receiving from the second network device, a first request for acquiring the set of capabilities identified by the first identifier and before sending, to the second network device, a first response including the set of capabilities identified by the first identifier, further comprising:
sending, to a fourth network device storing identifiers and corresponding sets of capabilities supported by terminal devices identified by each identifier, a second request for acquiring the set of capabilities identified by the first identifier; and
receiving, from the fourth network device, a second response including the set of capabilities identified by the first identifier.

7. The method according to claim 1, further comprising: if the first indication indicates the second network device does not support the feature,
sending, to the second network device, a set of capabilities supported by a second terminal device.

8. The method according to claim 7, before sending, to the second network device, a set of capabilities supported by a second terminal, further comprising:
sending, to a fourth network device storing identifiers and corresponding sets of capabilities supported by terminal devices identified by each identifier, a third request for acquiring the set of capabilities identified by a second identifier, wherein the second identifier identifies the set of capabilities supported by the second terminal device; and
receiving, from the fourth network device, a third response including the set of capabilities identified by the second identifier.

9. The method according to claim 2, wherein the third network device implements a Network Repository Function (NRF).

10. The method according to claim 6, wherein the fourth network device implements a User Equipment (UE) radio Capability Management Functions (UCMF).

11. The method according to claim 1, wherein
the first network device implements an Access and Mobility Management Function (AMF), the second network device is in a Radio Access Network (RAN); or
the first network device is a Mobility Management Entity (MME), the second network device is an evolved NodeB (eNB); or
the first network device implements a source AMF, the second network device implements a target AMF; or
the first network device is a source MME, the second network device is a target MME; or
the first network device implements an AMF, the second network device is an MME; or
the first network device is an MME, the second network device implements an AMF.

12. The method according to claim 1, wherein a set of capabilities supported by a terminal device comprising:
radio related capabilities during paging procedures; and/or
radio related capabilities during procedures except paging.

13. The method according to claim 1, wherein the feature of assigning an identifier to represent a set of capabilities supported by a terminal device is user equipment (UE) radio capability signalling optimisation (RACS).

14-20. (canceled)

21. A first network device, comprising:
at least one processor; and
at least one memory, the at least one memory containing instructions executable by the at least one processor, whereby the network device is operative to:
acquire a first indication indicating whether a second network device supports a feature of assigning an identifier to represent a set of capabilities supported by a terminal device; and
send to the second network device a first identifier of a set of capabilities supported by a first terminal device instead of the set of capabilities supported by the first terminal device, if the first indication indicates the second network device supports the feature.

22-26. (canceled)
